(19) United States
(12) Patent Application Publication
(10) Pub. No.: US 2010/0102485 A1
(43) Pub. Date: Apr. 29, 2010

(54) INJECTION MOLDING METHOD FOR MAKING LARGE AND THIN LIGHT GUIDE PLATE

(75) Inventor: GA-LANE CHEN, Santa Clara, CA (US)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/431,760

(22) Filed: Apr. 29, 2009

(30) Foreign Application Priority Data
Oct. 27, 2008 (CN) 200810305229.0

(51) Int. Cl. B29C 45/18

(52) U.S. Cl. 264/328.1

(57) ABSTRACT

An injection molding method for making a large and thin light guide plate, is provided. First, a first mold and a second mold are provided. The first and second molds each have a molding surface formed thereon. Second, the first mold and the second mold are incorporated together to define a chamber between the molding surfaces under a clamping force selected in a range from 4000 to 4500 kilonewton to the first and second molds. Third, inject a molding material into the chamber with an injection pressure selected in a range from 2000 to 4000 kilogram force per square centimeter and an injection velocity selected in a range from 800 to 1000 millimeter per second. Finally, the first mold and the second mold are separated to obtain the light guide plate.

### BACKGROUND

1. Technical Field

The present invention relates to injection molding, and particular, to an injection molding method for making a large and thin light guide plate.

2. Description of Related Art

Light guide plates are widely used in the back light modules of electronic devices, such as mobile phones and laptop computers. Because laptop computers have a larger screen than mobile phones, laptop computers require much larger light guide plates than mobile phones. The length and width of a light guide plate of a laptop computer is usually larger than 30 centimeters and 20 centimeters, respectively. Currently, for thin laptop computers the depth or thinness of a light guide plates is less than 1 centimeter.

A common method for making light guide plates of laptop computers is injection molding. However, because of the size of the light guide plates, defects such as porosity and shrinkage are likely to occur during the injection molding process, thus it is difficult to ensure quality of such large and thin light guide plates.

What is needed, therefore, is an injection molding method for making a large and thin light guide plate, which can overcome the above shortcomings.

### BRIEF DESCRIPTION OF THE DRAWINGS

Many aspects of present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a flowchart of an injection molding method for making a large and thin light guide plate in accordance with an exemplary embodiment.

FIG. 2 is a cross-sectional, partially cut-away view showing a first mold, a second mold, a first clamping plate, a second clamping plate, a toggle mechanism, a sprue and a screw used in the method of FIG. 1.

FIG. 3 is a cross-sectional view showing the first mold and the second mold shown in FIG. 2 are incorporated, thereby defining a chamber therebetween.

FIG. 4 is a cross-sectional view showing a molding material in the chamber shown in FIG. 3.

FIG. 5 shows the first mold and the second mold shown in FIG. 4 separated from each other, and a light guide plate.

### DETAILED DESCRIPTION OF THE EMBODIMENTS

Embodiments of the present method will now be described in detail below with reference to the drawings.

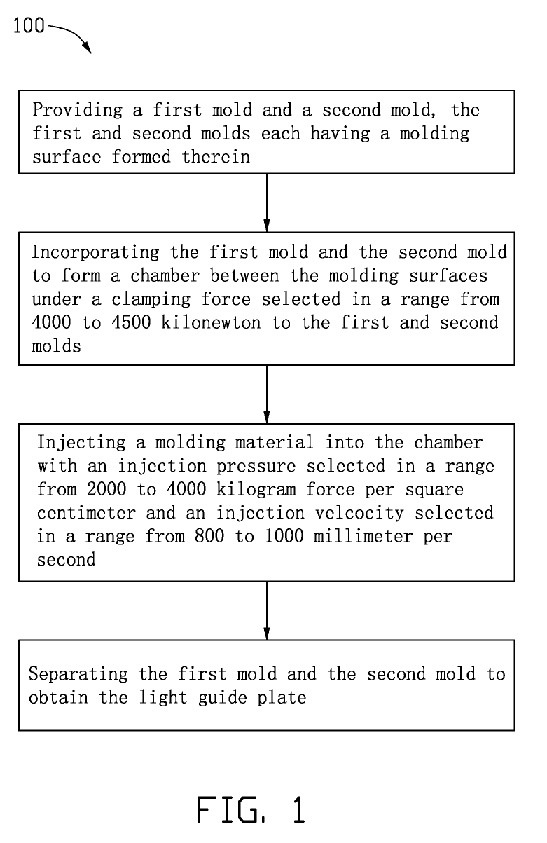

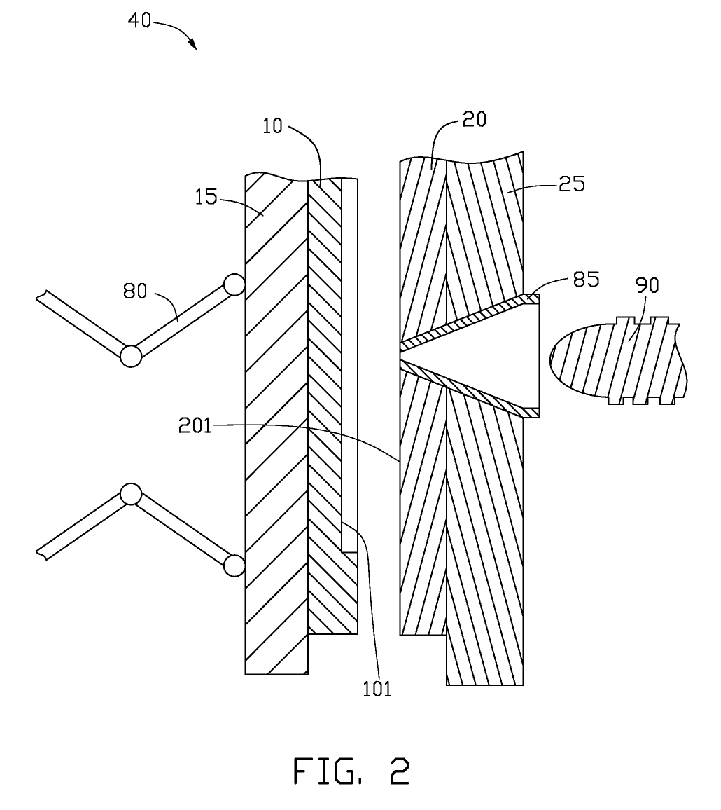

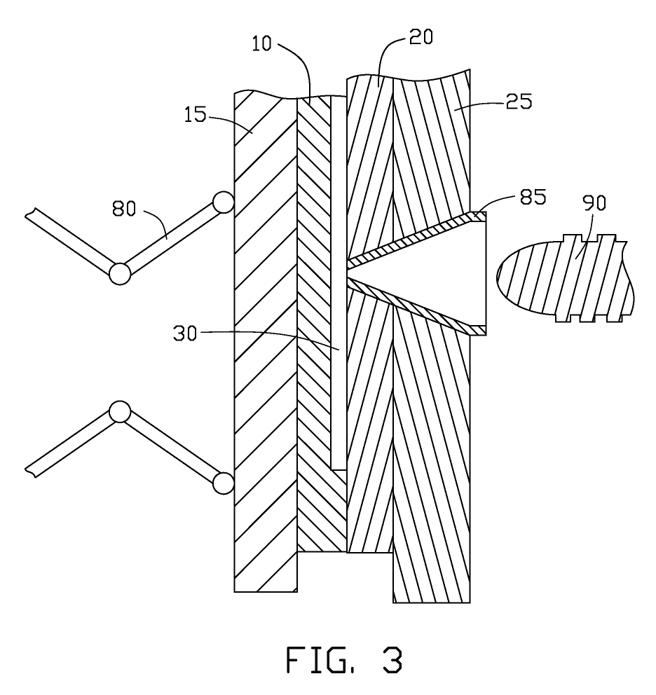

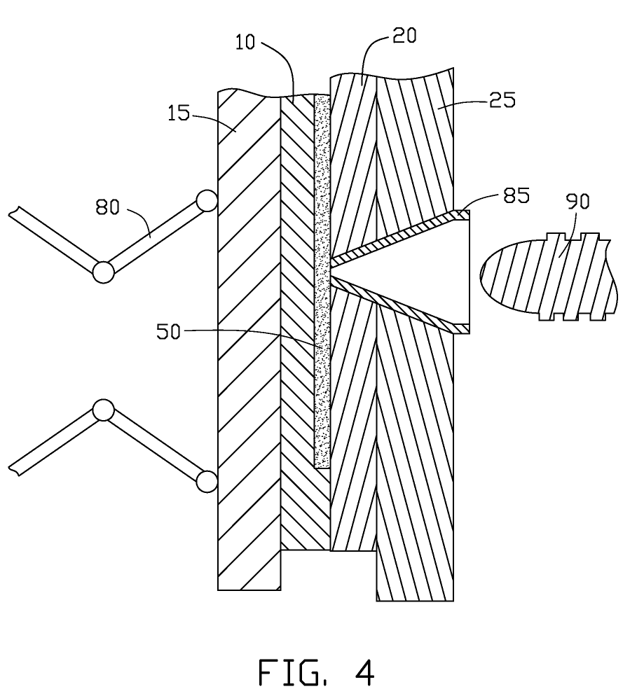

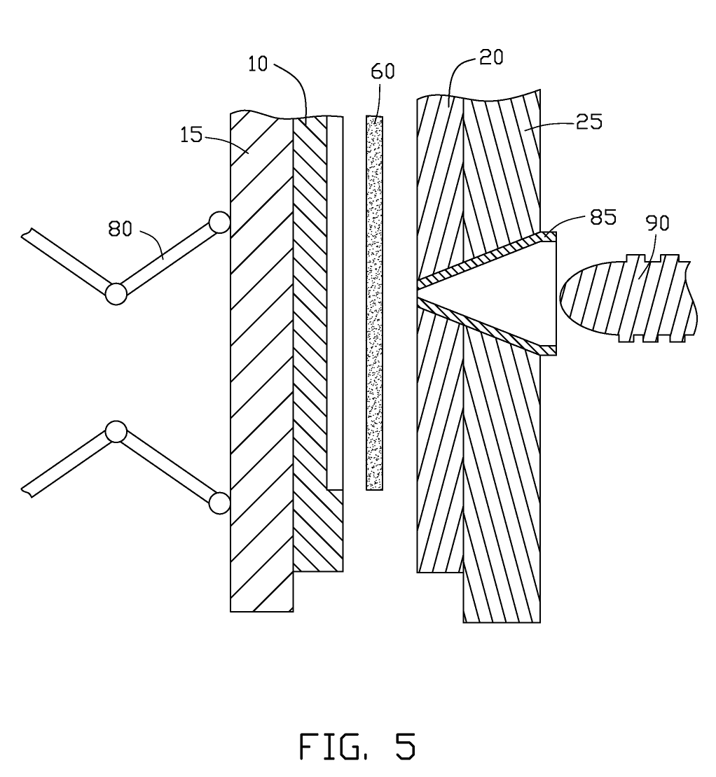

Referring to FIGS. 1 to 5, an exemplary injection molding method 100 for making a large and thin light guide plate 60, is provided. A length of the light guide plate 60 is in a range from 30 to 50 centimeters, a width of the light guide plate 60 is in a range from 20 to 35 centimeters, and a thickness of the light guide plate 60 is in a range from 0.4 to 0.8 millimeters. The method mainly includes the steps as follows.

First, a mold apparatus 40 is provided. The mold apparatus 40 includes a first mold 10, a second mold 20, a first clamping plate 15, a second clamping plate 25, a toggle mechanism 80, a sprue 85, and a screw 90. The first mold 10 is mounted to the first clamping plate 15, and the toggle mechanism 80 is mounted to the first clamping plate 15. The second mold 20 is mounted to the second clamping plate 25, and the sprue 85 is mounted to the second clamping plate 25. The screw 90 is rotatably movable relative to the sprue 85 under a pushing force in a range from 115 to 130 kilonewton, and configured for carrying a molding material 50 to the sprue 85.

The second clamping plate 25 together with the second mold 20 and the sprue 85 is fixed, and the first clamping plate 15 together with the first mold 10 is movable. The first mold 10 has a first molding surface 101 facing the second mold 20, and the second mold 20 has a second molding surface 201 facing the first mold 10. In the present embodiment, the first molding surface 101 is a rectangular recess in the surface of the first mold 10, and the second molding surface 201 is a flat surface, which is also the surface of the second mold 20. The tip of the nozzle of the sprue 85 is collinear with the surface of the second molding surface 201.

Second, incorporating the first mold 10 and the second mold 20 to form a chamber 30 between the first molding surface 101 and the second molding surface 201. The toggle mechanism 80 is capable of applying a clamping force selected in a range from 4000 to 4500 kilonewton to the first clamping plate 15, thus the first clamping plate 15 together with the first mold 10 is clamped to the second mold 20. In the present embodiment, the clamping force is about 4420 kilonewton. The toggle mechanism 80 is actuated by a servo motor (not shown). A power of the servo motor is in a range from 30 to 35 kilowatt. The dimension of the chamber 30 is precisely the same as the dimension of the light guide plate 60.

Third, the molding material 50 is injected into the chamber 30 with an injection pressure selected in a range from 2000 to 4000 kilogram force per square centimeter and an injection velocity selected in a range from 800 to 1000 millimeters per second. Preferably, the injection pressure is selected in a ranged from 3000 to 4000 kilogram force per square centimeter, and the injection velocity is 1000 millimeters per second. The push force applied on the screw 90 ensures the high injection pressure and injection velocity.

Finally, the first mold 10 is separated from the second mold 20 to obtain the light guide plate 60. Preferably, before the separation step, a cooling step is implemented to cool off the injected molding material 50 in the chamber 30, in other words, the light guide plate 60.

The high engaging force supports the high injection pressure and the high injection velocity. Due to the high injection pressure and the high injection velocity, the chamber 30 in such large size can be quickly filled soon, such that defects such as porosity and shrinkage can be avoided.

It is understood that the above-described embodiments are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. An injection molding method for making light guide plate, comprising:
providing a first mold and a second mold, the first and second molds each having a molding surface formed thereon;
incorporating the first mold and the second mold to define a chamber between the molding surfaces under a clamping force selected in a range from 4000 to 4500 kilonewton;
injecting a molding material into the chamber with an injection pressure selected in a range from 2000 to 4000 kilogram force per square centimeter and an injection velocity selected in a range from 800 to 1000 millimeter per second; and
separating the first mold and the second mold to obtain a light guide plate.

2. The method as described in claim 1, wherein a thickness of the light guide plate is in a range from 0.4 to 0.8 millimeters.

3. The method as described in claim 1, wherein a length of the light guide plate is in a range from 30 to 50 centimeters, and a width of the light guide plate is in a range from 20 to 35 centimeters.

4. The method as described in claim 1, wherein the clamping force is provided by a toggle mechanism.

5. The method as described in claim 1, wherein the injection pressure is selected in a ranged from 3000 to 4000 kilogram force per square centimeter.

6. The method as described in claim 1, wherein the injection velocity is 1000 millimeters per second.
